(19) United States
(12) Patent Application Publication
(10) Pub. No.: US 2024/0243926 A1
(43) Pub. Date: Jul. 18, 2024

(54) SYSTEM FOR A SECURE MODULAR CLOUD-ENABLED RESOURCE EXCHANGE APPARATUS

(71) Applicant: BANK OF AMERICA CORPORATION, Charlotte, NC (US)

(72) Inventors: Matthew Edward Williams, Frisco, TX (US); Paul Martin Mattison, Sherrills Ford, NC (US); John Philip Rice, Jacksonville, FL (US); Brian Joseph Smith, Saint Augustine, FL (US); Bryan Ward Follis, Jacksonville, FL (US)

(73) Assignee: BANK OF AMERICA CORPORATION, Charlotte, NC (US)

(21) Appl. No.: 18/098,503

(22) Filed: Jan. 18, 2023

(51) Int. Cl. H04L 9/32; H04L 9/40

(52) U.S. Cl. CPC H04L 9/3268; H04L 9/3247; H04L 63/10

(57) ABSTRACT

A system is provided for a secure modular cloud-enabled resource exchange apparatus. In particular, the resource exchange apparatus may comprise a security box operatively coupled to one or more modular components, which may include computing components or devices and/or peripherals. The components of the resource exchange apparatus may be secured using security certificates and/or tokens associated with the input and/or output ports of each component. The computing device within the resource exchange apparatus may be communicatively coupled with a cloud server, from which the computing device may retrieve security certificates, configuration parameters, and/or the like. Upon detecting that a component has invalid certificate, the system may automatically disconnect and block the component. In this way, the system may ensure that only authorized devices may be used within the resource exchange apparatus.

### FIELD OF THE INVENTION

The present invention embraces a system for a secure modular cloud-enabled resource exchange apparatus.

### BACKGROUND

There is a need for a resource exchange apparatus that is modular, secure, and communications-capable.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

A system is provided for a secure modular cloud-enabled resource exchange apparatus. In particular, the resource exchange apparatus may comprise a security box operatively coupled to one or more modular components, which may include computing components or devices and/or peripherals. The components of the resource exchange apparatus may be secured using security certificates and/or tokens associated with the input and/or output ports of each component. The computing device within the resource exchange apparatus may be communicatively coupled with a cloud server, from which the computing device may retrieve security certificates, configuration parameters, and/or the like. The system may further require that each component comprises an embedded security chip. Upon detecting that a component has an expired security certificate and/or the embedded security chip is malfunctioning or missing, the system may automatically disconnect and block the component. In this way, the system may ensure that only authorized devices may be used within the resource exchange apparatus.

Accordingly, embodiments of the present disclosure provide a system for a secure modular cloud-enabled resource exchange apparatus, the resource exchange apparatus comprising at least one non-transitory storage device; and at least one processor coupled to the at least one non-transitory storage device, wherein the at least one processor is configured to detect that a connection to a component of the resource exchange apparatus has been established; request a security certificate from the component; verify the security certificate by accessing a certificate repository hosted on a cloud server; based on verifying the security certificate, determine that the component is an authorized component; and based on determining that the component is an authorized component, grant communication and access rights to the component.

In some embodiments, the at least one processor is further configured to detect that a connection to a second component has been established; request a second security certificate from the component; determine that the second security certificate is invalid or missing; and reject the connection with to the second component.

In some embodiments, the component comprises an embedded security chip, wherein granting the communication and access rights to the component further comprises query the component to verify installation of the security chip; detect a presence of the security chip within the component; and authorize the connection to the component.

In some embodiments, verifying the security certificate comprises retrieving a public key from the certificate repository, wherein the public key is associated with a private key; using the public key, detect that the security certificate has been digitally signed using the private key; and based on detecting that the security certificate has been digitally signed using the private key, determine that the security certificate is genuine.

In some embodiments, the resource exchange apparatus comprises a card reader having a sensor installed thereon, wherein the sensor is configured to detect an impact to a card intake component of the card reader; and trigger an alarm based on detecting the impact.

In some embodiments, the resource exchange apparatus comprises a video camera positioned to capture a video stream of a card reader installed on the resource exchange apparatus, wherein the at least one processor is further configured to access an artificial intelligence module trained to analyze image data of the card reader; determine, using the artificial intelligence module, that at least one dimension of the card reader has changed; and trigger an alarm based on determining that the at least one dimension of the card reader has changed.

In some embodiments, the component comprises at least one of a card reader, NFC reader, display device, or QR code scanner.

Embodiments of the present disclosure also provide a computer program product for a secure modular cloud-enabled resource exchange apparatus, the computer program product comprising a non-transitory computer-readable medium comprising code causing the resource exchange apparatus to detect that a connection to a component of the resource exchange apparatus has been established; request a security certificate from the component; verify the security certificate by accessing a certificate repository hosted on a cloud server; based on verifying the security certificate, determine that the component is an authorized component; and based on determining that the component is an authorized component, grant communication and access rights to the component.

In some embodiments, the code further causes the resource exchange apparatus to detect that a connection to a second component has been established; request a second security certificate from the component; determine that the second security certificate is invalid or missing; and reject the connection with to the second component.

In some embodiments, the component comprises an embedded security chip, wherein granting the communication and access rights to the component further comprises query the component to verify installation of the security chip; detect a presence of the security chip within the component; and authorize the connection to the component.

In some embodiments, verifying the security certificate comprises retrieving a public key from the certificate repository, wherein the public key is associated with a private key; using the public key, detect that the security certificate has been digitally signed using the private key; and based on detecting that the security certificate has been digitally signed using the private key, determine that the security certificate is genuine.

In some embodiments, the resource exchange apparatus comprises a card reader having a sensor installed thereon, wherein the sensor is configured to detect an impact to a card intake component of the card reader; and trigger an alarm based on detecting the impact.

In some embodiments, the resource exchange apparatus comprises a video camera positioned to capture a video stream of a card reader installed on the resource exchange apparatus, wherein the code further causes the resource exchange apparatus to access an artificial intelligence module trained to analyze image data of the card reader; determine, using the artificial intelligence module, that at least one dimension of the card reader has changed; and trigger an alarm based on determining that the at least one dimension of the card reader has changed.

Embodiments of the present disclosure also provide a computer-implemented method for a secure modular cloud-enabled resource exchange apparatus, the computer-implemented method comprising detecting that a connection to a component of the resource exchange apparatus has been established; requesting a security certificate from the component; verifying the security certificate by accessing a certificate repository hosted on a cloud server; based on verifying the security certificate, determining that the component is an authorized component; and based on determining that the component is an authorized component, granting communication and access rights to the component.

In some embodiments, the computer-implemented method further comprises detecting that a connection to a second component has been established; requesting a second security certificate from the component; determining that the second security certificate is invalid or missing; and rejecting the connection with to the second component.

In some embodiments, the component comprises an embedded security chip, wherein granting the communication and access rights to the component further comprises query the component to verify installation of the security chip; detect a presence of the security chip within the component; and authorize the connection to the component.

In some embodiments, verifying the security certificate comprises retrieving a public key from the certificate repository, wherein the public key is associated with a private key; using the public key, detect that the security certificate has been digitally signed using the private key; and based on detecting that the security certificate has been digitally signed using the private key, determine that the security certificate is genuine.

In some embodiments, the resource exchange apparatus comprises a card reader having a sensor installed thereon, wherein the sensor is configured to detect an impact to a card intake component of the card reader; and trigger an alarm based on detecting the impact.

In some embodiments, the resource exchange apparatus comprises a video camera positioned to capture a video stream of a card reader installed on the resource exchange apparatus, wherein the computer-implemented method further comprises accessing an artificial intelligence module trained to analyze image data of the card reader; determining, using the artificial intelligence module, that at least one dimension of the card reader has changed; and triggering an alarm based on determining that the at least one dimension of the card reader has changed.

In some embodiments, the component comprises at least one of a card reader, NFC reader, display device, or QR code scanner.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for the system for a secure modular cloud-enabled resource exchange apparatus, in accordance with an embodiment of the present disclosure;

FIG. 2 illustrates an exemplary resource exchange apparatus, in accordance with an embodiment of the present disclosure; and

FIG. 3 illustrates a process flow for an exemplary function of the secure modular cloud-enabled resource exchange apparatus, in accordance with an embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (“GUI”) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, individual characteristic data (e.g., iris recognition, retina scans, fingerprints, finger veins, palm veins, palm prints, digital bone anatomy/structure and positioning of distal phalanges, intermediate phalanges, proximal phalanges, and/or the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “resource” may generally refer to physical or virtual objects that may be used to accomplish the entity's objectives. In this regard, the resources may include computing resources such as processing power, memory allocation, cache space, storage space, data files, network connections and/or bandwidth, electrical power, input/output functions, and the like, or data files (e.g., document files, media files, system files, and/or the like). In other embodiments, resources may refer to financial resources such as funds or digital currencies, where such resources may be linked to an account associated with a user.

“Resource exchange apparatus” as used herein may refer to a device configured to receive, output, and/or exchange resources with a user. Accordingly, in some embodiments, the resource exchange device may be an automated teller machine (“ATM”) that may provide an interface to a user for depositing, withdrawing, and/or exchanging financial resources (e.g., funds).

“Cloud computing” or “cloud computing technology” as used herein may refer to a system architecture in which services, functions, and/or resources may be used and/or provided in a distributed manner across multiple computing devices within a network environment. According, “cloud server” as used herein may refer to a server within the cloud computing environment that may be configured to provide computing services and/or resources to one or more endpoint devices.

A user may interface with a resource exchange apparatus (e.g., an ATM that may be owned and/or operated by an entity such as a financial institution) for a variety of purposes, such as to withdraw or deposit funds, submit account status inquiries, change account settings, and/or the like. That said, there is a need for a resource exchange apparatus with increased modularity to extend the service life of such devices as well as simplify maintenance. Furthermore, there is a need to increase the security of the apparatus in order to protect against unauthorized access or use of the apparatus and/or its internal components (e.g., card skimming attempts, apparatus hijack attempts, and/or the like).

To address the above scenarios among others, embodiments of the present disclosure provide a system for a secure modular cloud-enabled resource exchange apparatus. The resource exchange apparatus may comprise a security box (e.g., a safe for containing resources, such as cash) that may be operatively coupled to one or more components. The components may include electronic and/or computing devices or peripherals. Accordingly, the components may include a central computing device such as a system-on-chip (“SoC”) device, single board computer (“SBC”) device, or the like, that may be connected to peripherals such as a display device (e.g., an LCD or LED screen), user input devices (e.g., keypads, keyboards, touchscreens, microphones, and/or the like), data input devices (e.g., card readers, check readers, and/or the like), communications devices (e.g., NFC devices, Wi-Fi devices, QR code scanners, Bluetooth devices, and/or the like), output devices (e.g., speakers, printers, and/or the like), and/or the like.

Each component within the resource exchange apparatus may comprise input and/or output ports for connecting to the central computing device, where the input and/or output ports are protected using security certificates and/or secure tokens. In this regard, the central computing device may connect to the cloud server to retrieve updated security certificates and/or tokens associated with each of the individual components. During the installation and/or connection process, whereby each component is connected to the central computing device, the central computing device may perform a security check on each connected component. Accordingly, if the system detects that a certificate or token associated with any of the components is invalid (e.g., the certificate is expired or missing), the system may reject the connection to the component with the invalid credentials. In some embodiments, each component may further comprise a hardware security module (e.g., a security chip) embedded within component. In such embodiments, the system may perform a check to determine whether the security chip is present within the component. For instance, the system may query the component through the communication channel between the centralized computing device and the component and wait a response from the security chip. In other embodiments, the centralized computing device may be coupled to an internal hardware-based security chip detection device that may scan components for the presence of the security chip. If the system determines that the security chip is not present within a component that is connected to the centralized computing device (e.g., via the I/O ports, a wireless connection, and/or the like), the system may automatically reject the connection with a component that lacks the security chip.

The apparatus may further include additional security mechanisms, such as anti-tampering protection. For instance, the apparatus may equip one or more of the components with sensors (e.g., motion and/or impact triggered sensors) that may trigger an alarm if tampering is detected within the component. In an exemplary embodiment, the apparatus may include a card reader (e.g., RFID card reader, credit card reader, access card reader, and/or the like) equipped with sensors near the card intake area. If the sensor is triggered (e.g., by pressure or impact from attempting to install a card skimmer), the sensor may activate an alarm (e.g., a siren or buzzing sound, flashing lights, auditory verbal messages, and/or the like). The alarm may further transmit a message to the cloud server to notify the entity regarding the incident, where the message may include information such as an apparatus ID number, location of the incident, time of the incident, and/or the like. In some embodiments, the apparatus may be equipped with a forward-facing camera that may be configured to capture an image, sound sample, or video of the user. Accordingly, if the alarm is triggered, the system may capture a media file of the unauthorized user and transmit the media file to the cloud server for analysis.

In some embodiments, the apparatus may further be equipped with additional cameras that may monitor the various components of the apparatus. For instance, a camera may be pointed at the card intake portion of the card reader to capture a continuous video feed. The system may use an artificial intelligence module that has been trained to recognize when the card intake area and/or the card reader itself has become deformed or has changed dimension (e.g., a skimmer has been overlayed on top of the card intake area). In such embodiments, the system may activate the alarm and/or transmit a notification to the entity's cloud servers that a potential tampering of a component has been logged.

The system as described herein provides a number of technological benefits over conventional resource exchange devices. In particular, by using security certificates and security chips with each component within the resource exchange apparatus, the system may protect the resource exchange apparatus against unauthorized access attempts (e.g., by connecting unauthorized or compromised components). Furthermore, the additional security features further protect the user from unauthorized uses of the user's resources. Finally, the modular nature of the resource exchange apparatus makes it more easily upgradable and serviceable.

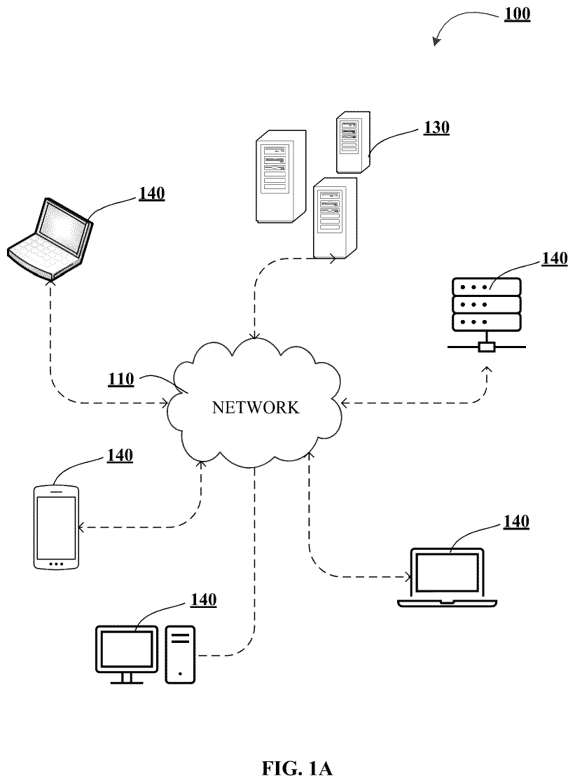

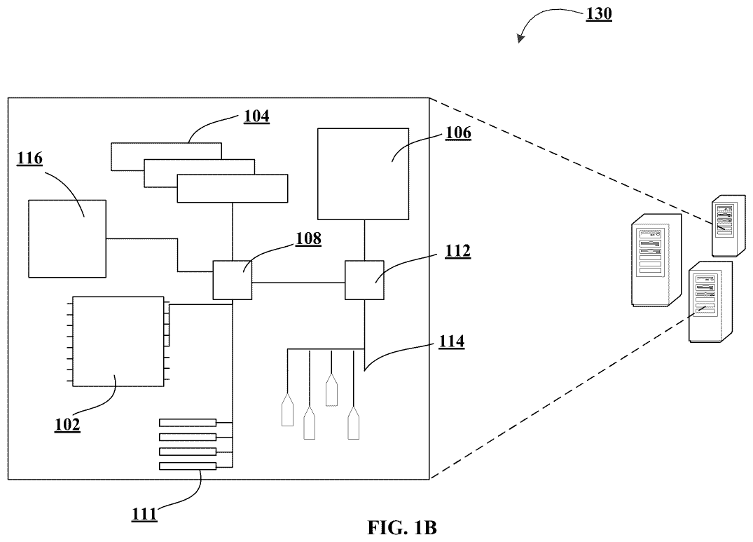

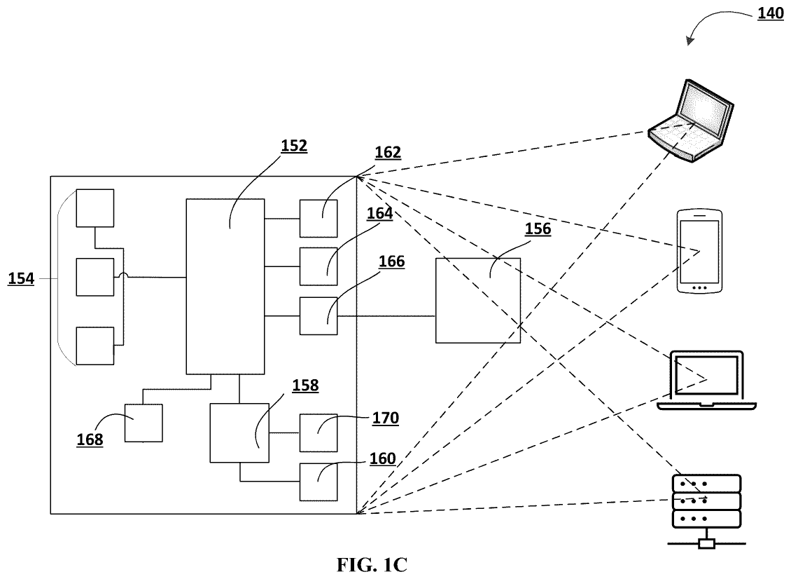

FIGS. 1A-1C illustrate technical components of an exemplary distributed computing environment 100 for the system for a secure modular cloud-enabled resource exchange apparatus. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. For instance, the functions of the system 130 and the endpoint devices 140 may be performed on the same device (e.g., the endpoint device 140). Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it. In some embodiments, the system 130 may provide an application programming interface (“API”) layer for communicating with the end-point device(s) 140.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as servers, networked storage drives, personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

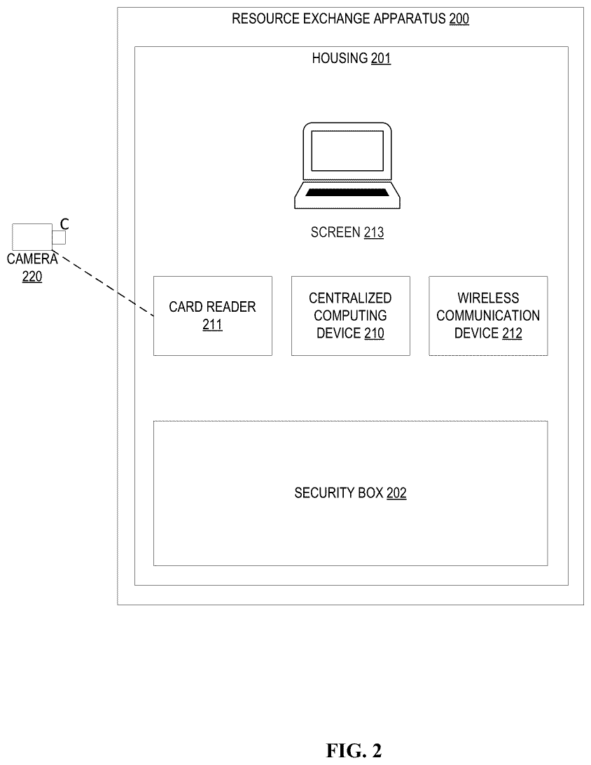

FIG. 2 illustrates an exemplary resource exchange apparatus 200, in accordance with some embodiments of the present disclosure. The resource exchange apparatus may comprise an exterior housing 201 having a security box 202 and multiple components stored therein. The components may include a centralized computing device 210 connected to a card reader 211, wireless communication device 212, and a screen 213 (collectively, “the components”). The security box 202 may be a container that stores the resources that are used by the resource exchange apparatus 200. In this regard, the security box 202 may be a safe for holding cash within an ATM. In such embodiments, the security box 202 may be structured to include a single opening that serves as the sole entry and exit point for the resources stored therein. The security box 202 may further comprise a security key with metal conductors that may communicate with any devices or components that may be attached to the safe. The security key may be configured to query the components to ensure that any components attached to the safe are authorized and authentic. In some embodiments, the security box 202 may be surrounded by a metallic (e.g., steel) chassis or cage that may be integrated with the security box 202 and serves to secure the security box 202 to the housing 201.

The centralized computing device 210 may be a computing device (e.g., an endpoint device as described in FIGS. 1A-1C) such as a single board computer, system on chip, or other type of computer that may be integrated into the resource exchange apparatus 200. Accordingly, the centralized computing device 210 may handle the processing tasks of the resource exchange apparatus 200 (e.g., running a resource exchange application, which may allow the user to perform such functions as depositing or withdrawing resources, viewing account statuses and/or making account-related changes, depositing checks, and/or the like). The centralized computing device 210 may be connected to a cloud server within the entity's system to perform the security verification and/or machine learning-based analysis of video feeds as described elsewhere herein. In some embodiments, the resource exchange apparatus 200 may be equipped with sensors positioned to detect a presence of a user. If no user is detected by the sensors, the centralized computing device 210 may enter a low power consumption “sleep mode” until the sensor detects the presence of a user. In some embodiments, the centralized computing device 210 may be configured to institute a location-based restriction on its functionality. For instance, if the centralized computing device 210 detects that the resource exchange apparatus 200 or any of its components have been moved outside of an authorized geographic region (e.g., by comparing a GPS-based location of the component with the location of the authorized region), the centralized computing device 210 may automatically shut down and prevent the functions of the resource exchange application from being executed.

The card reader 211 may be a device for interfacing with a device or object provided by a user. Accordingly, the card reader 211 may be a credit card reader, cash reader, check reader, RFID badge reader, and/or the like. In some embodiments, the card reader 211 may be equipped with security features that may be related to anti-tampering measures. For example, the card intake portion of the card reader 211 may be equipped with touch or impact activated sensors that may activate an alarm when tampering is detected (e.g., a card skimmer is attempted to be installed on the card intake.) In some embodiments, the resource exchange apparatus 200 may further comprise a camera 220 that captures a video and/or audio feed of a component, such as the card reader 211. In this regard, the camera 220 may capture a constant media stream of the card reader 211. The centralized computing device 210 may access an artificial intelligence module (e.g., which may be stored within the centralized computing device 210 or alternatively within the cloud network) that has been trained to recognize signs of tampering from image data. Accordingly, the artificial intelligence module may be configured to sense whether the card reader 211 has been deformed or has changed dimension. In some embodiments, the camera 220 (or an additional camera within the housing 201) may be positioned to capture an image of the user. Accordingly, in some embodiments, the camera 220 may capture a media file of the user when tampering has been detected. The media file may then be transmitted to the cloud server by the centralized computing device 210 for further processing.

The wireless communication device 212 may be a component that interfaces with a device of the user over a wireless communication channel. Accordingly, the wireless communication device 212 may be a near-field communication (“NFC”) reader, Bluetooth reader, QR code reader, Bluetooth communication interface, and/or the like. In an exemplary embodiment, the user (e.g., a customer of the entity) may use a mobile device such as a smart phone to connect to the resource exchange apparatus 200 through the wireless communication device 212 to access the functions therein.

Each of the components 211, 212, 213 may be connected to the centralized computing device 210 through ports that are secured through certificates and/or tokens. Each component may be required to be associated with a valid certificate in order to be connected to the centralized computing device 210. Certificates and/or component firmwares may be updated by the centralized computing device 210 through the connection to the cloud servers. In some embodiments, each component may further comprise a security chip that identifies the component as an authorized component. Accordingly, the centralized computing device 210 may, upon being connected to the component, attempt to query the security chip to check for the presence of the security chip.

The housing 201 may comprise multiple parts that are securely fastened to one another (e.g., using clips with a security mechanism that may require a specialized tool for access). The housing 201 may comprise one or more smart lights coupled to the centralized computing device 210, where the smart lights may illuminate to highlight various different parts of the resource exchange apparatus 200 depending on which area the centralized computing device 210 has determined is the intended area of focus for the user in real time. For instance, if the user is withdrawing cash, a smart light positioned to illuminate the cash withdrawal box may light up when the cash has been dispensed. The housing 201 may further comprise a series of light emitting diodes (LEDs) that may allow the housing 201 to change color.

In some embodiments, the resource exchange apparatus 200 may be designed to be serviceable without the servicer leaving the armored vehicle. For instance, in some embodiments, the housing 201 may further comprise an RFID tag that may be used by servicers to identify the unit for service. A security probe may be attached to the security box 202 to unlock the security box 202 to move cash or checks in and out of the security box 202.

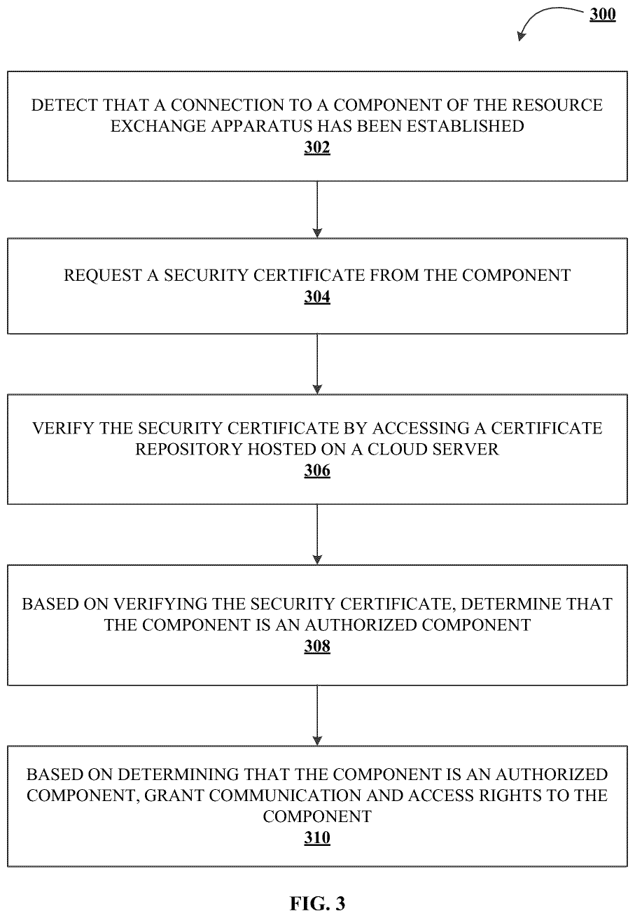

FIG. 3 illustrates a process flow 300 for provisioning authenticated access to resources linked with individual characteristic data, in accordance with an embodiment of the present disclosure. The process begins at block 302, where the system detects that a connection to a component of the resource exchange apparatus has been established. In this regard, the connection may be a hard wire connection that may be established between an I/O port of the component and an interface of the centralized computing device. Each of the ports of the components may be associated with a security certificate and/or token such that connections using such ports must be verified and validated before the connection is permitted.

The process continues to block 304, requests a security certificate from the component. In this regard, a genuine security certificate may have been digitally signed by a trusted certificate authority (e.g., the financial institution that operates the resources exchange device) using a private key. Accordingly, if the security certificate is genuine, the recipient of the certificate (e.g., the centralized computing device) may perform the verification by requesting the certificate from the component through the connection between the component and the centralized computing device, then subsequently decrypting the certificate using the public key associated with the private key that has been used to digitally sign the certificate.

The process continues to block 306, where the system verifies the security certificate by accessing a certificate repository hosted on a cloud server. In this regard, the accessing the certificate repository may comprise downloading a public key associated with the private key used to digitally sign the security certificate. Using the public key, the centralized computing device may verify whether the security certificate has been signed using the private key associated with the public key. In this way, the system may determine the authenticity of the component that is being connected to the centralized computing device.

The process continues to block 308, where the system, based on verifying the security certificate, determines that the component is an authorized component. In this regard, if the system is able to decrypt the certificate using the public key associated with the private key, the system may determine that the component has been certified by the authorizing entity (e.g., the financial institution) and thereby determine that the component is safe to use. However, if the system is unable to decrypt the certificate using the public key, or if the system detects that the certificate has not been provided by the component, the system may determine that the component is an unauthorized component and subsequently reject the connection with the unauthorized component.

The process continues to block 310, where the system, based on determining that the component is an authorized component, grants communication and access rights to the component. By verifying component certificates in this way, the system may prevent the connection of unauthorized and potentially compromised components from being connected to the centralized computing device, which in turn may prevent the resource exchange apparatus from being compromised. In some embodiments, each component may further comprise a security chip that is embedded within the component, where the security chip may be a hardware IC module configured to carry out cryptographic processes. In such embodiments, the system may further be configured to query to determine the presence of the security chip within the component. If no security chip is detected, the system may reject the connection between the component and the centralized computing device. If the security chip is detected, the system may authorize the connection and allow the component to communicate with the centralized computing device.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for a secure modular cloud-enabled resource exchange apparatus, the resource exchange apparatus comprising:
at least one non-transitory storage device; and
at least one processor coupled to the at least one non-transitory storage device, wherein the at least one processor is configured to:
detect that a connection to a component of the resource exchange apparatus has been established;
request a security certificate from the component;
verify the security certificate by accessing a certificate repository hosted on a cloud server;
based on verifying the security certificate, determine that the component is an authorized component; and
based on determining that the component is an authorized component, grant communication and access rights to the component.

2. The system of claim 1, wherein the at least one processor is further configured to:
detect that a connection to a second component has been established;
request a second security certificate from the component;
determine that the second security certificate is invalid or missing; and
reject the connection with to the second component.

3. The system of claim 1, wherein the component comprises an embedded security chip, wherein granting the communication and access rights to the component further comprises:
query the component to verify installation of the security chip;
detect a presence of the security chip within the component; and
authorize the connection to the component.

4. The system of claim 1, wherein verifying the security certificate comprises:
retrieving a public key from the certificate repository, wherein the public key is associated with a private key;
using the public key, detect that the security certificate has been digitally signed using the private key; and
based on detecting that the security certificate has been digitally signed using the private key, determine that the security certificate is genuine.

5. The system of claim 1, wherein the resource exchange apparatus comprises a card reader having a sensor installed thereon, wherein the sensor is configured to:
detect an impact to a card intake component of the card reader; and
trigger an alarm based on detecting the impact.

6. The system of claim 1, wherein the resource exchange apparatus comprises a video camera positioned to capture a video stream of a card reader installed on the resource exchange apparatus, wherein the at least one processor is further configured to:
access an artificial intelligence module trained to analyze image data of the card reader;
determine, using the artificial intelligence module, that at least one dimension of the card reader has changed; and
trigger an alarm based on determining that the at least one dimension of the card reader has changed.

7. The system of claim 1, wherein the component comprises at least one of a card reader, NFC reader, display device, or QR code scanner.

8. A computer program product for a secure modular cloud-enabled resource exchange apparatus, the computer program product comprising a non-transitory computer-readable medium comprising code causing the resource exchange apparatus to:
detect that a connection to a component of the resource exchange apparatus has been established;
request a security certificate from the component;
verify the security certificate by accessing a certificate repository hosted on a cloud server;
based on verifying the security certificate, determine that the component is an authorized component; and
based on determining that the component is an authorized component, grant communication and access rights to the component.

9. The computer program product of claim 8, wherein the code further causes the resource exchange apparatus to:
detect that a connection to a second component has been established;
request a second security certificate from the component;
determine that the second security certificate is invalid or missing; and
reject the connection with to the second component.

10. The computer program product of claim 8, wherein the component comprises an embedded security chip, wherein granting the communication and access rights to the component further comprises:
query the component to verify installation of the security chip;
detect a presence of the security chip within the component; and
authorize the connection to the component.

11. The computer program product of claim 8, wherein verifying the security certificate comprises:
retrieving a public key from the certificate repository, wherein the public key is associated with a private key;
using the public key, detect that the security certificate has been digitally signed using the private key; and
based on detecting that the security certificate has been digitally signed using the private key, determine that the security certificate is genuine.

12. The computer program product of claim 8, wherein the resource exchange apparatus comprises a card reader having a sensor installed thereon, wherein the sensor is configured to:
detect an impact to a card intake component of the card reader; and
trigger an alarm based on detecting the impact.

13. The computer program product of claim 8, wherein the resource exchange apparatus comprises a video camera positioned to capture a video stream of a card reader installed on the resource exchange apparatus, wherein the code further causes the resource exchange apparatus to:
access an artificial intelligence module trained to analyze image data of the card reader;
determine, using the artificial intelligence module, that at least one dimension of the card reader has changed; and
trigger an alarm based on determining that the at least one dimension of the card reader has changed.

14. A computer-implemented method for a secure modular cloud-enabled resource exchange apparatus, the computer-implemented method comprising:
detecting that a connection to a component of the resource exchange apparatus has been established;
requesting a security certificate from the component;
verifying the security certificate by accessing a certificate repository hosted on a cloud server;
based on verifying the security certificate, determining that the component is an authorized component; and
based on determining that the component is an authorized component, granting communication and access rights to the component.

15. The computer-implemented method of claim 14, wherein the computer-implemented method further comprises:
detecting that a connection to a second component has been established;
requesting a second security certificate from the component;
determining that the second security certificate is invalid or missing; and
rejecting the connection with to the second component.

16. The computer-implemented method of claim 14, wherein the component comprises an embedded security chip, wherein granting the communication and access rights to the component further comprises:
query the component to verify installation of the security chip;
detect a presence of the security chip within the component; and
authorize the connection to the component.

17. The computer-implemented method of claim 14, wherein verifying the security certificate comprises:
retrieving a public key from the certificate repository, wherein the public key is associated with a private key;
using the public key, detect that the security certificate has been digitally signed using the private key; and
based on detecting that the security certificate has been digitally signed using the private key, determine that the security certificate is genuine.

18. The computer-implemented method of claim 14, wherein the resource exchange apparatus comprises a card reader having a sensor installed thereon, wherein the sensor is configured to:
detect an impact to a card intake component of the card reader; and
trigger an alarm based on detecting the impact.

19. The computer-implemented method of claim 14, wherein the resource exchange apparatus comprises a video camera positioned to capture a video stream of a card reader installed on the resource exchange apparatus, wherein the computer-implemented method further comprises:
accessing an artificial intelligence module trained to analyze image data of the card reader;
determining, using the artificial intelligence module, that at least one dimension of the card reader has changed; and
triggering an alarm based on determining that the at least one dimension of the card reader has changed.

20. The computer-implemented method of claim 14, wherein the component comprises at least one of a card reader, NFC reader, display device, or QR code scanner.
